(19) United States
(12) Patent Application Publication
(10) Pub. No.: US 2010/0225826 A1
(43) Pub. Date: Sep. 9, 2010

(54) METHOD OF LOCATING A RECEIVER THAT REDISTRIBUTES CONTENT

(75) Inventors: Arnoldus Johannes Lucas Maria Maandonks, Eindhoven (NL); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/293,618

(22) PCT Filed: Mar. 20, 2007
(86) PCT No.: PCT/IB07/50962

§ 371 Date: Sep. 19, 2008

(30) Foreign Application Priority Data
Mar. 24, 2006 (EP) 06111662.0

(51) Int. Cl. H04N 5/44; G06K 9/00

(52) U.S. Cl. 348/725; 382/100; 348/E05.096

(57) ABSTRACT

A method of identifying from a plurality of receivers a receiver which causes a redistribution of content, the method comprising making available a watermarked version of the content to only a subset of the plurality of receivers, determining if the watermarked version is subsequently being distributed, and eliminating one or more receivers from the plurality based on the determination, until the subset comprises only the receiver which causes the redistribution, thereby identifying this receiver. Preferably a binary search algorithm is used. Also a system for distributing content to a plurality of receivers, configured to execute the method.

A recent phenomenon on the Internet is watching (almost) live television broadcasts, for example sports events, for free by using a peer-to-peer distribution network. One user of the network needs to stream the television broadcast to the network. All other users then can watch that stream through the network, and may participate in further distribution by making that stream available to yet other users. This phenomenon was reported in for example the news article “Newest export from China: Pirated pay TV”, Wall Street Journal, Sep. 2, 2005.

The broadcaster or other rights holder for the broadcast in question often has not granted permission for such redistribution. In such situations it is desirable to be able to discover which user, or at least which device, is streaming the television broadcast to the network. It is known to embed identifiers using watermarking technology in the content. When the content is originally made available, the identifier is coupled to a particular receiver or purchaser. This allows identification of that receiver or purchaser when the content is discovered in an unauthorized location.

This type of forensic tracking works well when a content item is made available to one particular receiver or purchaser. However, television is usually broadcast to multiple receivers at once. Embedding an identifier for a particular receiver or purchaser now is no longer possible, making it hard to use the above-mentioned forensic tracking technique in this situation.

It is possible to enable forensic tracking for broadcasted content by adding a watermark embedded in each receiver, so that any content redistributed from that receiver carries a watermark that is unique that receiver. This adds significant cost. Moreover it requires a list of all identifiers associated with all receivers.

It is an object of the invention to provide a computer-implemented method of identifying from a plurality of receivers a receiver which causes a redistribution of content that does not require a receiver-unique identifier to be watermarked in the content.

According to the invention, the method comprises making available a watermarked version of the content to only a subset of the plurality of receivers, determining if the watermarked version is subsequently being distributed, and eliminating one or more receivers from the plurality based on the determination, until the subset comprises only the receiver which causes the redistribution, thereby identifying this receiver.

If the receivers in the subset receive the watermarked version, and subsequently time the version of the content available on the network does not carry the watermark, these receivers can be eliminated and a different subset can be selected. If the receivers in the subset receive the watermarked version, and subsequently the version of the content available on the network does carry the watermark, then the receiver to be identified must be in the subset. The subset can then be subdivided yet again and the method is repeated.

Note that in this context “subsequently” preferably means occurring within a time period of a few seconds up to several minutes or even hours. The invention has particular application to the identification of receivers that engage in near real time redistribution of the content. It is however conceivable that the invention also can be used for the identification of receivers that (purposefully or for other reasons) delay the redistribution for longer periods. Of course the longer the delay, the longer it will take to identify the receivers.

Preferably a binary search algorithm is employed. In this embodiment the receivers are partitioned in two groups. The receivers in the first group are provided with the watermarked version. The receivers in the second group are provided with the unwatermarked version. If the watermarked version then appears on the network, the receivers in group two can be eliminated. Otherwise the receivers in group one can be eliminated. Subsequently the subset (group one or group two, respectively) is divided into two groups yet again and the method is repeated until the receiver is identified.

Alternatively one could e.g. select a certain number of receivers and make the watermarked version available to them. If subsequently the version of the content available on the network does not carry the watermark, these receivers can be eliminated and a new number of receivers can be selected.

In an embodiment transmission of the content to the identified receiver is blocked such that the redistribution is prevented. This may be done for a certain period of time, for example the duration of the content item that is being redistributed. As an example, a live transmission of an important event could be redistributed. The duration of the blocking may then be chosen equal to the remaining time of the live transmission.

The method according to the invention may be initiated automatically upon detecting in the redistributed content a trigger watermark. Its purpose is to allow automatic detection of the presence of the content on the redistribution network. By subsequently initiating the automated search method for the receiver, detection of redistribution may be done fully automatically. Optionally even the blocking of the identified receiver may be done automatically. Alternatively the method may be initiated manually.

The invention further provides a system implementing the method. Advantageous embodiments of the invention are set out in the dependent claims.

The invention will now be discussed in more detail with reference to the figures, in which:

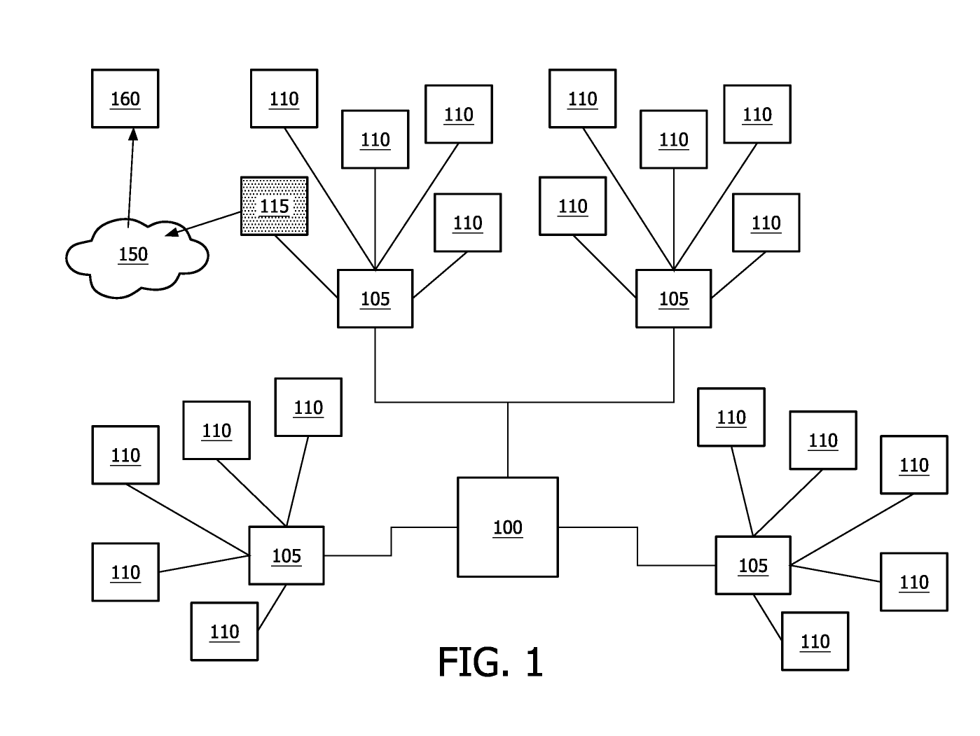

FIG. 1 schematically illustrates a system for distributing content to a plurality of receivers; and

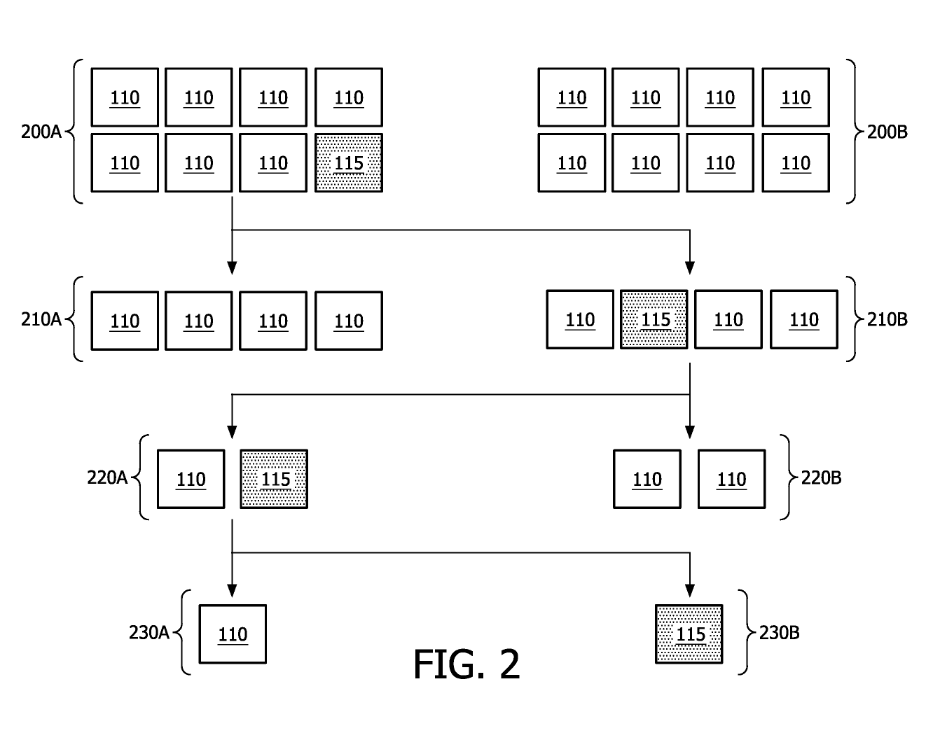

FIG. 2 schematically illustrates a preferred embodiment of the method of identifying from a plurality of receivers a receiver which causes a redistribution of content.

Throughout the figures, same reference numerals indicate similar or corresponding features. Some of the features indicated in the drawings are typically implemented in software, and as such represent software entities, such as software modules or objects.

FIG. 1 schematically illustrates a system for distributing content to a plurality of receivers 110, 115. The system comprises a central node 100 connected to a plurality of intermediate nodes 105. Each intermediate node 105 is in turn connected to a plurality of receivers 110. The central node 100 distributes content, preferably live content such as television programs, by sending it to the intermediate nodes 105 which in turn distribute the content to the receivers 110, 115 to which they are connected.

Such systems for content distribution are well known from e.g. audiovisual broadcasting systems such as television. The system can be used to allow people to watch live sporting events simultaneously, for instance. However the invention has application not just for television broadcasting, but also for other ways of distribution and for other types of content.

Of course in practice a system like this could have many more intermediate levels between the central node 100 and the receivers 110.

In the system there is a receiver 115 which causes a redistribution of the content on a network 150 such as the Internet. The redistribution is usually done by streaming the content as it is received to nodes on the network 150. The content may be subjected to certain processing operations before redistributing it. For example, the resolution may be reduced, the content may be compressed, certain parts (e.g. advertisements) may be removed, and so on.

The receiver 115 is typically embodied as a personal computer running peer-to-peer video streaming software. An example of such software is the PPLive program, available at the priority date of the present application on the Internet using the URL: http://www.pplive.com/en/index.shtml

Another example of such software is Sopcast, available at the priority date of the present application on the Internet using the URL: http://www.sopcast.org/

It is assumed that this redistribution is unauthorized, which means it is desirable that this receiver 115 be identified so that appropriate measures can be taken. To this end according to the present invention a watermarked version of the content is made available to only a subset of the plurality of receivers.

Techniques for watermarking content by themselves are well known. Because for the present invention the watermark does not need to carry an identifier of any particular receiver or user, any watermarking technology may be employed. A single bit of payload suffices.

A monitoring station 160 is provided that monitors the redistribution as it occurs on the network 150. The station 160 could for instance connect to the PPLive network to receive the redistributed content. The station 160 then attempts to detect the watermark in the redistributed content to determine if the watermarked version is being distributed.

Based on this determination, one or more receivers are eliminated from the plurality of receivers. A new subset is formed from the remaining receivers and the process is repeated until the subset comprises only the receiver 115 which causes the redistribution, thereby identifying this receiver 115. This process is discussed in more detail below with reference to FIG. 2.

Once the receiver 115 has been identified, a transmission of the content to the identified receiver 115 is preferably blocked such that the redistribution is prevented. In some embodiments it is not possible to uniquely identify the personal computer in question itself, but rather only a household or perhaps even only the locality in which the personal computer is present can be identified. The receiver would then be the household or locality in question.

In such cases blocking the transmission to the identified receiver 115 would also affect other devices in that household or locality, which may be undesirable. Other measures could be taken, such as warning the owner of the household or the members of the locality that transmissions will be blocked unless the unauthorized redistribution is ceased.

In one embodiment, the watermarked version of the content is created in the central node 100 and distributed to a subset of the intermediate nodes 105 which distribute it to the receivers 110, 115 to which they are connected. An unwatermarked version is distributed to the other intermediate nodes. This has the advantage that only one watermark embedder is necessary. Subsequently these other intermediate nodes and all receivers connected to them can be eliminated if the watermarked version is still redistributed on the network 150. By repeatedly eliminating intermediate nodes this way, the intermediate node to which the receiver 115 can be identified.

Alternatively the watermarked version of the content may be made available to only the receivers connected to one intermediate node at a time.

In another embodiment, the watermarked version of the content is created in a subset of the intermediate nodes 105. The central node 100 determines this subset and membership in the subset is then communicated to these intermediate nodes. This has the advantage that the central node 100 only needs to distribute one, unwatermarked version of the content.

In this embodiment each intermediate node in the subset preferably embeds a different watermark in the content. The multiple watermarked versions are distributed to the receivers simultaneously. The monitoring station 160 then should detect not only the presence of a watermark but also which watermark was embedded. With this information the intermediate node 105 to which the receiver 115 is connected is immediately identified. This is faster than when the central node 100 embeds one watermark and distributes the watermarked version to the subset of intermediate nodes 105.

Alternatively only one intermediate node distributes the watermarked version of the content at a time. This is a linear search algorithm among the intermediate nodes.

Once the intermediate node 105 to which the receiver 115 is connected has been identified, the watermarked version of the content is made available to only a subset of the receivers connected to this intermediate node 105, in accordance with the method described below with reference to FIG. 2. This way the receiver 115 will be individually identified.

The intermediate node 105 may be provided with the means for repeatedly eliminating receivers from the subset. Alternatively the central node 100 may be provided with these means. In that case, the central node 100 signals to the intermediate node 105 to which receivers the intermediate node 105 should send the watermarked version, and to which receivers it should send the unwatermarked version.

The monitoring station 160 may initiate the process of detection automatically upon detecting in the redistributed content a trigger watermark. The trigger watermark should then be present in the content as it is originally distributed to the receivers 110, 115.

FIG. 2 schematically illustrates a preferred embodiment of the method of identifying from a plurality of receivers 110, 115 a receiver 115 which causes a redistribution of content. The receiver 115 which causes the redistribution is indicated in FIG. 2 with shading. For the sake of example, the plurality of receivers 110, 115 is chosen here as sixteen receivers. The embodiment described below uses a binary search algorithm.

In a first step, all receivers are grouped into two groups 200A and 200B, preferably of equal size. Grouping devices may be done according to any criterion, for example based on device identifier or customer/owner name. Preferably however the grouping is done by intermediate node: all devices connected to one intermediate node should be put in the same group. Grouping devices then can be done by dividing the intermediate nodes 105 into groups.

Next, the watermarked version of the content is made available to the receivers of group 200A, and the unwatermarked version is made available to the receivers of group 200B. Subsequently the above-mentioned detection is performed to see whether the redistributed version of the content contains the watermark present in the watermarked version. This will be the case since the receiver 115, which causes the redistribution, is comprised in group 200A.

Hence in a next step the receivers of group 200B are eliminated from the search, and the receivers of group 200A are grouped into two groups 210A and 210B. Next, the watermarked version of the content is made available to the receivers of group 210A, and the unwatermarked version is made available to the receivers of group 210B. Subsequently the above-mentioned detection by the monitoring station 160 is performed to see whether the redistributed version of the content contains the watermark present in the watermarked version. This will not be the case, since the receiver 115 is not comprised in group 210A.

Therefore now the watermarked version of the content is made available to the receivers of group 210B, and the unwatermarked version is made available to the receivers of group 210A. The check is repeated, and now the watermark will be found to be present in the redistributed version.

Accordingly the receivers of group 210A are eliminated from the search, and the receivers of group 210B are grouped into two groups 220A and 220B. Now the watermarked version of the content is made available to the receivers of group 220A, and the unwatermarked version is made available to the receivers of group 220B. The check is repeated, and now the watermark is again found to be present in the redistributed version.

The receivers from group 220B are eliminated from the search, and the receivers of group 220A are grouped into two groups 230A and 230B. As this is the final stage, each group comprises only one receiver. Now the watermarked version of the content is made available to the receiver of group 230A, and the unwatermarked version is made available to the receiver of group 230B. Since receiver 115 is comprised in group 230B, the watermark will not be found in the redistributed version of the content.

Because the groups each contain only one receiver, it is now known that it must be the receiver in group 230B that redistributes the content. As an extra check to be sure, the watermarked version may still be made available to this receiver.

While the above method is in progress, receivers that have been eliminated can be provided with the unwatermarked version of the content.

Optionally the method may be performed several times in parallel, for example once for group 200A and once for group 200B, using different watermarked versions of the content. This achieves simultaneous detection of multiple receivers causing redistribution of the content.

It should be noted that the above-mentioned embodiments illustrate rather than limit the invention, and that those skilled in the art will be able to design many alternative embodiments without departing from the scope of the appended claims. For example, the monitoring station 160 may be comprised in the central node 100. The means for embedding the watermark or selecting the intermediate nodes 105 may be provided in a separate location.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In device or system claims enumerating several means, some or all of these means can be embodied by one and the same item of hardware. The mere fact that certain measures are recited in mutually different dependent claims does not indicate that a combination of these measures cannot be used to advantage.

1. A computer-implemented method of identifying from a plurality of receivers a receiver which causes a redistribution of content, the method comprising making available a watermarked version of the content to only a subset of the plurality of receivers, determining if the watermarked version is subsequently being distributed, and eliminating one or more receivers from the plurality based on the determination, until the subset comprises only the receiver which causes the redistribution, thereby identifying this receiver.

2. The method of claim 1, further comprising being initiated automatically upon detecting in the redistributed content a trigger watermark.

3. The method of claim 1, comprising employing a binary search algorithm to eliminate the one or more receivers from the plurality.

4. The method of claim 1, comprising blocking a transmission of the content to the identified receiver such that the redistribution is prevented.

5. The method of claim 1, further comprising watermarking the watermarked version of the content with a payload of a single bit.

6. A system for distributing content to a plurality of receivers, comprising distribution means for making available a watermarked version of the content to only a subset of the plurality of receivers, determining means for determining if the watermarked version is subsequently being distributed, and selecting means for eliminating one or more receivers from the plurality based on the determination, the system being configured for operating the distribution, determining and selecting means until the subset comprises only the receiver which causes the redistribution, thereby identifying this receiver.

7. The system of claim 6, wherein the distribution means and the selecting means are comprised in a central distribution node connected to a plurality of intermediate nodes, which in turn are connected to respective subsets of the plurality of receivers.

8. The system of claim 6, comprising a central distribution node connected to a plurality of intermediate nodes, which in turn are connected to respective subsets of the plurality of receivers, in which the selecting means are comprised in at least one of said intermediate nodes.

9. The system of claim 8, wherein the distribution means are configured for making available the watermarked version of the content to one or more intermediate nodes at a time, the selecting means being configured for eliminating all receivers connected to these one or more intermediate nodes from the plurality upon the determining means determining that the watermarked version is not being distributed subsequent to the making available of the watermarked version of the content to the subset of receivers.
